(19) United States
(12) Patent Application Publication
(10) Pub. No.: US 2020/0062163 A1
(43) Pub. Date: Feb. 27, 2020

(54) Portable Livestock Handling Apparatus Employing Front-Only Lifting Jack for Transition Between Transport Mode and Field Use

(71) Applicant: Northquip Inc., Woodlands (CA)

(72) Inventors: Stephen Arthur Langrell, Woodlands (CA); Philip Malcolm Firth, Woodlands (CA)

(21) Appl. No.: 16/536,561

(22) Filed: Aug. 9, 2019

(30) Foreign Application Priority Data
Nov. 30, 2018 (CA) PCT/CA2018/051497

(51) Int. Cl. B60P 3/04; A01K 1/02; B60P 1/02

(52) U.S. Cl. CPC B60P 3/04; B60P 1/02; A01K 1/0272

(57) ABSTRACT

A portable livestock apparatus has a frame, removable transport wheels situated on a wheel axis located intermediately between opposing front and rear ends of the frame, and a front lifting jack mechanism disposed forwardly of the wheel axis. Transition of the apparatus between a ground-seated field-use position and a wheel-carried transport position is performed using only the front lifting jack mechanism, without requiring a separate rear lifting jack mechanism behind the wheel axis to enable installation and removal of the transport wheels. Full extension of the front lifting jack mechanism raises the front end far enough to provide sufficient ground clearance at the wheel axis for installation and removal of the transport wheels. A singular lift-lower operation by the singular jack thus enables both hitch connection/disconnection and wheel installation/removal.

### CROSS-REFERENCE TO RELATED APPLICATIONS

This application claims foreign priority benefit under 35 U.S.C. 119(a) of PCT Application No. PCT/CA2018/051497, filed Nov. 26, 2018, the entirety of which is incorporated herein by reference.

### FIELD OF THE INVENTION

The present invention relates generally to livestock handling equipment, and more particularly to portable livestock handling apparatuses convertible between a wheel-carried transport position and a ground-seated field-use position.

### BACKGROUND

In the forgoing category of livestock handling equipment, Applicant's prior product offerings include the Portable Q-Catch Cattle Handling System, which is a mobile unit featuring an elongated frame that, from front to rear, carries a pull tongue for connection to the hitch of a pickup truck or other tow vehicle, a livestock squeeze chute, a livestock alleyway and a livestock force tub. A pair of transport wheels resides on a shared wheel axis situated intermediately between the front and rear ends of the frame at a location generally underlying the point at which the alleyway exits the force tub to lead forwardly therefrom into the squeeze chute. A front lifting jack is attached to the frame near the front end thereof, and a separate rear lifting jack is attached to the frame at a rear section thereof a short distance behind the wheel axis.

In a transport mode for travelling to an intended site of field use, both jacks are raised out of contact with the ground to enable wheeled travel of the unit behind a tow vehicle to which the unit is coupled via the pull tongue. To setup the unit for field use upon arrival at the site, the front lifting jack is extended down to the ground so that the weight of the unit is borne on the transport wheels and front lifting jack, at which point the pull tongue is disconnected from the vehicle hitch, and then removed from the frame. The front lifting jack is then collapsed to lower the front end of the frame down to ground level. The rear jack is then extended in order to lift the rear end of the frame to a sufficient angle of inclination at which the transport wheels are lifted off the ground to enable removal of the transport wheels from the frame. The rear jack is then collapsed to lower the rear end of the frame down to ground level, thus seating the entire frame flat atop the ground in the absence of the transport wheels to accomplish the ground-seated field-use position of the unit. The setup process thus requires two separate jacking operations performed with the front and rear jacks, respectively.

Transition of the unit back into its wheel-carried transport mode similarly requires two separate jacking operations via the separate front and rear lifting jacks, first lifting the rear end of the frame with the rear jack to a sufficient height allowing replacement of the transport wheels, followed by collapse of the rear jack to lower the re-installed transport wheels onto the ground, and then lifting the front end of the frame with the front lifting jack to enable re-installation of the pull tongue and coupling thereof to the hitch of the tow vehicle.

Portable livestock corrals known in the prior art, such as the Wrangler Portable Corral by Linn Post & Pipe, Inc. and the Express Corral by WW Manufacturing, use electric-over-hydraulic control of similarly placed front and rear jacks situated on opposite sides of the wheel axis to perform the transport/field-use transition via two separate jacking operations.

Other portable livestock handling units, such as those shown in U.S. Pat. Nos. 4,214,555, 5,924,385, 7,146,933, 7,146,933, 8,276,929 and 9,226,476 take a different approach to the transition between transport and field use modes, where instead of removal of the transport wheels to prepare the units for field use, the axles of the transport wheels are movably mounted to the frame to enable shifting of the transport wheels between stowed positions of matching or greater elevation than the frame to enable seating of the frame on the ground, and deployed positions lowered below the frame for rolling support thereof on the ground.

U.S. Pat. No. 3,020,882 discloses a mobile livestock chute useable in a ground-seated position as a holding chute, and an inclined position usable as a loading chute for loading livestock onto a transport vehicle. The transport wheels are removable in the ground-seated position, and a lifting jack pivotally coupled to a telescopically adjustable and removable pull tongue is used to lift the frame into the inclined loading position. Transition of the unit between its two modes of operation requires several actions, including simultaneous manipulation of both a hand crank of the lifting jack and a ratchet actuator of the telescopic pull tongue, deployment and locking of additional support posts at the front of the frame, unlocking and re-angulation of side walls of the chute, and subsequent removal of the pull tongue and attached jack.

The prior art solutions thus require manipulation of a plurality of different mechanisms to transition the units between transport mode and field-use positions. In view of the forgoing, there remains a need for portable livestock equipment offering improved design and procedural simplicity in relation to its transition between these two different modes.

### SUMMARY OF THE INVENTION

According to a first aspect of the invention, there is provided a mobile livestock handling apparatus comprising:

a frame having a front end and opposing rear end spaced apart in a longitudinal direction;

a pull tongue placed, or configured for selective placement, in a position extending longitudinally forward from the front end of the frame for connection to a hitch of a towing vehicle at a leading end of said pull tongue;

transport wheels connected or connectable to the frame at opposing lateral sides thereof at a wheel axis lying transversely of the longitudinal direction at a position situated intermediately of the front and rear ends of the frame in the longitudinal direction; and

a front lifting jack mechanism comprising one or more front lifting jacks that are attached to the frame at a location residing forwardly of the wheel axis, and are extendable down into contact with a ground surface beneath the frame and operable to lift the front end of the frame about the wheel axis and thereby simultaneously lower the rear end of the frame about the wheels axis;

wherein the one or more front lifting jacks are configured to be extendable far enough to lower the rear end of the frame into contact with the ground surface, and subsequently lift the transport wheels off the ground surface.

Preferably the apparatus is free of any rear lifting jacks situated rearwardly of the wheel axis.

According to a second aspect of the invention, there is provided a method of setting up the mobile livestock handling apparatus of the forgoing type for field use, said method comprising:

(a) towing said apparatus to a setup site using a tow vehicle having a hitch to which the pull tongue of the apparatus is connected;

(b) at said setup site, with the pull tongue of the apparatus still connected to the hitch of the tow vehicle, extending the front lifting jack mechanism down into contact with the ground surface;

(c) with the front lifting jack mechanism extended down into said contact with the ground surface, disconnecting the pull tongue of the apparatus from the hitch of the tow vehicle;

(d) performing further extension of the front lifting jack mechanism to lower the rear end of the frame into contact with said ground surface;

(e) with said rear end of the frame in contact with the ground surface, performing even further extension of the front lifting jack mechanism to increase an inclination angle of the apparatus relative to the ground surface and thereby lift the transport wheels from said ground surface;

(f) with the inclination angle large enough to lift said transport wheels from the ground surface, removing said transport wheels from the frame; and

(g) with the transport wheels removed, collapsing the front lifting jack mechanism to lower the front end of the frame down to the ground surface, thereby laying said frame atop the ground surface.

According to a third aspect of the invention, there is provided a method of preparing the mobile livestock handling apparatus of the forgoing type for transport, said method comprising:

(a) with the apparatus initially residing in a ground-seated state with the frame seated on said ground surface and the transport wheels removed, extending the front lifting jack mechanism to lift the front end of the frame to a height at which an inclination angle of said frame relative to the ground surface is great enough that a distance from the wheel axis to the ground surface exceeds a radius of the transport wheels;

(b) with the apparatus at said inclination angle, installing the transport wheels on the frame;

(c) collapsing the front lifting jack to lower the front end of the frame, thereby reducing said inclination angle and lowering said transport wheels into contact with said ground surface;

(d) with the transport wheels in said contact with the ground surface, further collapsing the front lifting jack mechanism to lift the rear end of the frame from the ground surface;

(e) with the pull tongue in an installed position reaching forwardly from the front end of the frame, collapsing the front lifting jack mechanism even further to lower the pull tongue into connectable relation to a hitch of a tow vehicle;

(f) connecting the pull tongue to said hitch; and

(g) with the pull tongue connected to said hitch, further collapsing the front lifting jack to a raised position lifted from the ground surface to enable towing of the apparatus on the transport wheels via the pull tongue and the hitch.

According to a fourth aspect of the invention, there is provided a method of setting up a portable livestock apparatus comprising a frame, transport wheels situated on a wheel axis located intermediately between opposing front and rear ends of the frame, and a front lifting jack mechanism disposed forwardly of the wheel axis, said method comprising using the front lifting jack mechanism and transport wheels to bear a weight of the apparatus during disconnection thereof from a tow vehicle hitch, extending the front lifting jack mechanism to lower the rear end of the frame down into contact with a ground surface, further extending the front lifting jack mechanism to increase an inclination angle of the frame relative to said ground surface and thereby lift the transport wheels from said ground surface, removing the transport wheels from the frame, and collapsing the front lifting jack mechanism to lower the front end of the frame down to the ground surface, thereby laying said frame atop the ground surface.

According to a fifth aspect of the invention, there is provided a method of preparing to transport a portable livestock handling apparatus comprising a frame, transport wheels situated on a wheel axis located intermediately between opposing front and rear ends of the frame, and a front lifting jack mechanism disposed forwardly of the wheel axis, said method comprising, with the apparatus initially in a ground-seated state with the frame seated on a ground surface and the transport wheels removed, using the front lifting jack mechanism to lift the front end of the frame to a height at which an inclination angle of said frame relative to the ground surface is great enough that a distance from the wheel axis to the ground surface exceeds a radius of the transport wheels, installing the transport wheels on the frame while holding the frame at said inclination angle with the front lifting jack, collapsing the front lifting jack mechanism to lower the transport wheels to the ground surface, further collapsing the front lifting jack mechanism to lift the rear end of the frame from the ground surface and lower a front pull tongue of the apparatus into connectable relation to a tow vehicle hitch, connecting the pull tongue to said tow vehicle hitch, and further collapsing the front lifting jack mechanism out of contact with the ground surface to enable towing of the apparatus on the transport wheels via the pull tongue and the tow vehicle hitch.

### BRIEF DESCRIPTION OF THE DRAWINGS

One embodiment of the invention will now be described in conjunction with the accompanying drawings in which:

FIG. 1 is a side elevational view of a portable livestock handing apparatus of the present invention in a wheel-carried transport position for hitched towing behind a truck or other tow vehicle.

FIG. 2 is a side elevational view of the apparatus of in a first stage of transition from said transport position to a field-use position.

FIG. 3 is a side elevational view of the apparatus in a second stage of transition from the transport position to the field-use position.

FIG. 4 is a side elevational view of the apparatus in a third stage of transition from the transport position to the field-use position.

FIG. 5 is a side elevational view of the apparatus in a fourth stage of transition from the transport position to the field-use position.

FIG. 6 is a side elevational view of the apparatus in the field-use position.

FIG. 7 is a side elevational view of the apparatus in a first stage of transition from the field-use position back to the transport position.

FIG. 8 is a side elevational view of the apparatus in a second stage of transition from the field-use position back to the transport position.

FIG. 9 is a side elevational view of the apparatus in a third stage of transition from the field-use position back to the transport position.

FIG. 10 is a side elevational view of the apparatus in a fourth stage of transition from the field-use position back to the transport position.

### DETAILED DESCRIPTION

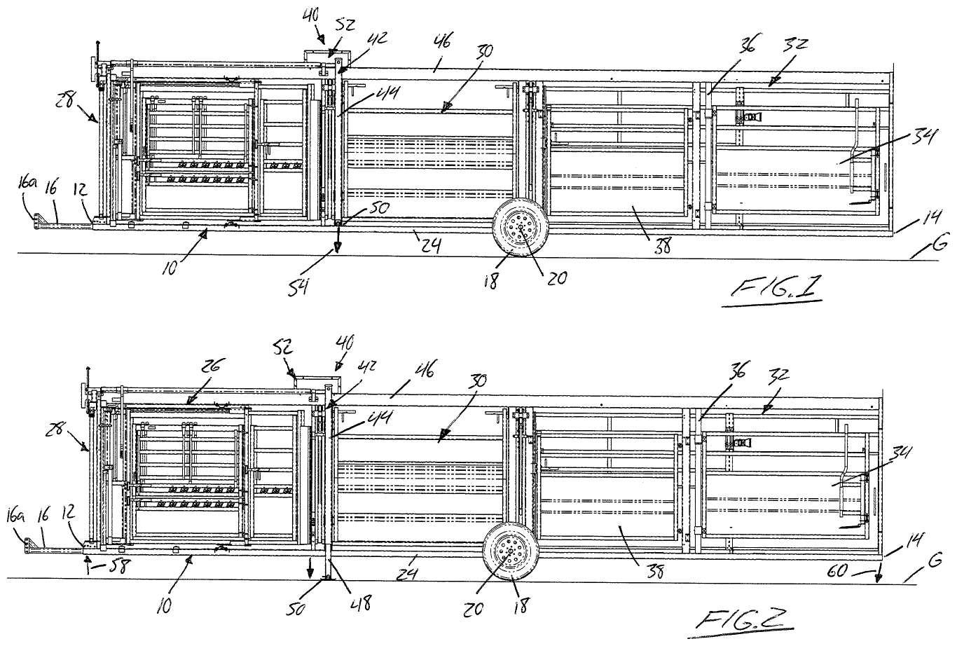

FIG. 1 shows a portable livestock handling apparatus of the present invention, which like Applicant's aforementioned Q-Catch product features an elongated frame 10 having front and rear ends 12, 14 situated oppositely one another in a longitudinal direction of the elongated frame, a removable pull tongue 16 projecting longitudinally forward from the frame 10 at the front end 12 thereof, and a pair of transports wheels 18 situated outboard of the frame 10 on opposite sides thereof at an intermediate location spaced from, and situated generally centrally between, the front and rear ends 12, 14 of the frame 10. The transport wheels 18 are rotatable relative to the frame on a shared wheel axis 20 that lies perpendicularly transverse to the longitudinal direction of the frame.

This wheel axis is defined at a fixed location on the frame, for example by a cross-tube 22 affixed in perpendicular relation to outer longitudinal beams 24 of the frame that define the opposite sides thereof. In addition to the cross-tube 22, the longitudinal beams are also perpendicularly interconnected by additional cross-members at the front and rear ends 12, 14 of the frame 10 to define an overall rectangular shape thereof, the structural integrity may also be reinforced by additional cross-braces likewise spanning perpendicularly between the longitudinal beams at select intervals therealong between the front and rear frame ends. Such general frame structure is known in the art, and thus not further described or illustrated herein in particular detail.

Each transport wheel 18 is mounted to a rotatable wheel hub at an outer end of a respective support shaft whose opposing inner end is removably received in a respective end of the cross tube 22. Each support shaft is selectively fastenable to the cross-tube 22 when inserted therein by a respective lock pin (not shown) fed through aligned apertures in the cross-tube and support shaft. The cross-tube and the support shafts of the transport wheels are preferably of rectangular (e.g. square) cross-section to prevent relative rotation therebetween and to enable easier alignment of the pin apertures with one another under insertion of the support shafts into the cross-tube.

Such pinned connection of a transport wheel support shaft to a frame cross-tube of a mobile livestock facility is known in the art, and thus not further described or illustrated herein in particular detail.

A front section of the frame spanning from the wheel axis 20 to the front end 12 of the frame 10 carries thereatop a livestock squeeze chute 26 whose head gate 28 is situated at the front end 12 of the frame, and a livestock alleyway 30 spanning rearwardly from the opposite entrance end of the squeeze chute to toward a livestock force tub 32 that is carried on a rear section of the frame that spans from the wheel axis 20 to the rear end 14 of the frame. One side of the force tub features a peripheral tub wall that curves about an upright axis lying perpendicular to the longitudinal direction of the frame. The peripheral tub wall features a convex outer side facing outwardly from the respective side of the frame 10 (the side thereof opposite the viewing plane of the figures), and a concave inner side facing oppositely of the convex outer side. A movable barrier panel 34 is pivotally coupled to an upright center post 36 of the force tub to enable swinging movement of the barrier panel 34 along the concave inner side of the curved peripheral tub wall to encourage movement of livestock toward the alleyway 30 for routing of the livestock one-by-one to the squeeze chute.

The illustrated force tub has an entrance opening that is situated on the same side of the center post as the alleyway, and that is normally obstructed by a movable closure gate 38 pivotally supported for swinging movement about another upright axis near and parallel to that of the movable barrier. The swinging closure gate can thus be opened to enable admission of livestock to the force tub through the entrance opening, and then swung closed and locked to prevent the livestock from exiting the tub through said entrance opening. In other embodiments, such a movable closure gate may be omitted, with the tub instead being permanently closed between the alleyway 30 and the tub's center post 36, in which case admission of livestock instead relies on swinging of the movable barrier 34 to an open position enabling livestock access to the interior of the force tub on the opposite side of the center post 36 nearest to the rear end 14 of the frame 10.

The apparatus features a front lifting jack mechanism 40 with a pair of front lifting jacks 42 each residing outboard of the frame on a respective side thereof at a fixed location situated intermediately between the wheel axis 20 and the front end 12 of the frame in the longitudinal direction thereof. The illustrated example has the jacks 42 placed generally midway between the wheel axis 20 and front frame end 12, at a location where the front end of the alleyway 30 opens into the rear entrance of the squeeze chute 26, but it will be appreciated from the following description that the particular location of the jacks 42 may vary, provided that they reside forwardly of the wheel axis 20. Each jack 42 features tubular outer housing 44 standing in perpendicularly upright and fixed relation to the respective longitudinal beam 24 on the respective side of the frame, and for example may be mounted to an upright post that perpendicularly spans between this longitudinal beam 24 of the frame and a corresponding longitudinal header 46 that spans the full length of the frame 10 in elevated relation thereover in a position parallel to and generally aligned with the respective longitudinal beam 24. These uprights and headers cooperate with the frame to define an overall skeletal structure of the apparatus by which the other components of the squeeze chute, alleyway, force tub and lifting jack mechanism are supported.

An extendable/retractable leg 48 of each lifting jack 42 has an upper end thereof received in the outer housing 42, and is selectively extendable and retractable from an open bottom end of the housing 44 that resides at a close elevation above the respective longitudinal beam 24, but in slightly outboard relation thereto. The lower end of the extendable/retractable leg 48, and a respective ground foot 50 pivotally coupled thereto, can thus move upwardly and downwardly past the plane of the elongated frame 10 just outside the respective longitudinal beam 24. The ground foot 50 is pivotable relative to the jack leg 48 on a horizontal pivot axis that is perpendicularly transverse to an actuation axis on which the jack leg 48 is linearly displaceable back and forth in the jack housing 44. This pivot axis of the ground foot 50 is parallel to the wheel axis 20 of the transport wheels so that the foot can maintain an level orientation placed flat atop the ground during tilting of the frame 10 about the wheel axis in the various transition stages shown in the drawings and described herein further below.

A drive unit 52 of the jack mechanism features an enclosure mounted atop the headers 46 of the structural skeleton in overlying relation to the frame at a location between the upper ends of the jack housings 44. The drive unit enclosure contains an electric motor and a gear train cooperatively engaged between the motor driveshaft and each of the jacks 42, whereby operation of the electric motor in one direction drives downward extension of the jack legs 48, and in the other direction drives collapse of the jacks by retracting the jack legs 48 further upwardly into the jack housings 44. These two jacks 42 situated forwardly of the wheel axis 18 are the only two lifting jacks of the entire apparatus, whereby there are no rear lifting jacks of any kind situated on the rear section of the frame behind the wheel axis, nor are there any lifting jacks on the pull tongue 16 that reaches forwardly from the front end 12 of the frame 10. Though preferably removable from the frame, the pull tongue 16 may be a fixed-length tongue of non-telescopic construction.

The location of the wheel axis 18 is selected such that the front section of the apparatus located between the wheel axis and the front end of the frame is heavier than the rear section located between the wheel axis and the rear end of the frame. As a result, the center of mass is situated forwardly of the wheel axis 20 to give the apparatus a front-heavy weight distribution under which the front end of the frame 10 is biased gravitationally downward about the wheel axis 18. The front-heavy weight distribution thus biases the rear end of the frame upwardly in opposite relation to the downwardly biased front end.

Having described the structure of the apparatus, attention is now turned to its operation. FIG. 1 shows the apparatus in its wheel-carried transport state, where the transport wheels 18 support the frame in elevated above a road or ground surface over which the apparatus is towable by connection of a leading end 16a of the pull tongue to the hitch of a truck or other tow vehicle (not shown). The apparatus is towed to an intended site of use, where the stages shown in FIGS. 2 through 5 are then carried out in order to transition the apparatus into a field-use position shown in FIG. 6, where the frame is no longer supported by the transport wheels 18, and is instead laid flat atop the ground surface G at the intended site of use in order to be accessible to livestock at said site.

Referring to FIG. 1, upon arrival at the intended site of use, the pull tongue 16 is initially retained in its coupled relation to the hitch of the tow vehicle, and the drive unit 52 is activated to operate the motor thereof in the direction driving downward extension of the jack legs 48, as shown by arrow 54, until the jack feet 50 come into contact with the ground surface G underlying the frame 10. Extended into contact with the ground surface, and in view of the front-heavy weight distribution of the apparatus, the jacks 42 are thus now co-operable with the transport wheels 18 to bear the full weight of the apparatus and hold the frame in elevated relation above the ground surface, and so the leading end 16a of the pull tongue 16 is now disconnected from the hitch of the tow vehicle.

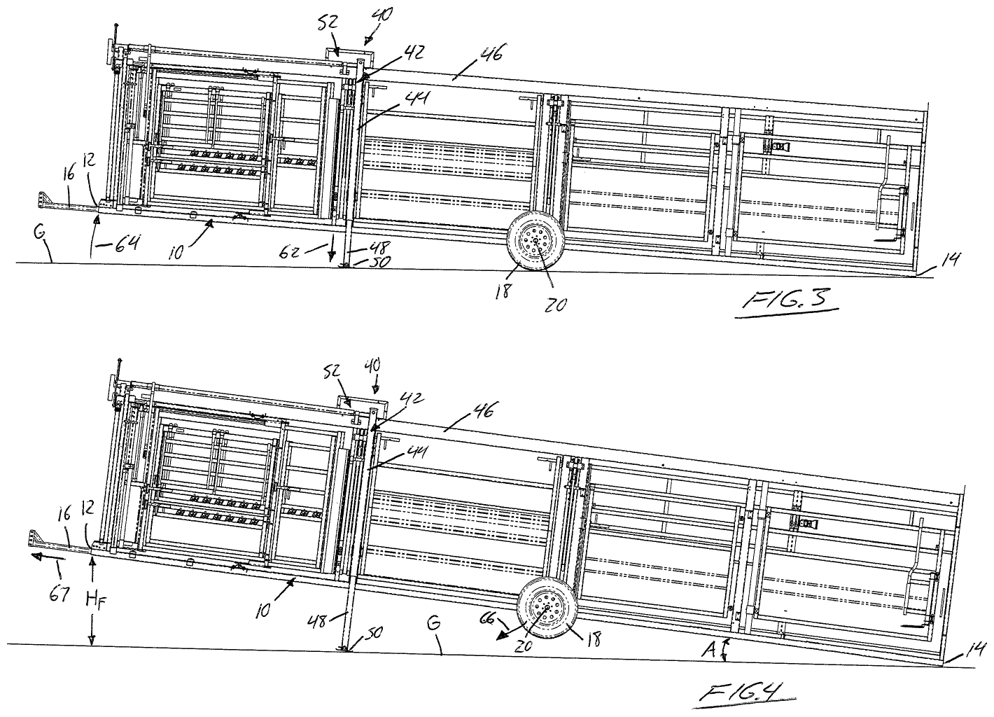

Turning to FIG. 2, once the pull tongue 16 has been disconnected from the tow vehicle, the jacks 42 are extended further downward, as shown by arrow 56, thus acting to lift up the front end 12 of the frame 10, as denoted by arrow 58, while lowering the opposite rear end 14 of the frame 10 downwardly toward the ground surface, as denoted by arrow 60. Turning to FIG. 3, this extension of the jacks 42 eventually brings the frame's rear end 14 into contact with the ground surface G, at which point continued extension of the jacks 42, as denoted by arrow 62, acts to further lift the front end 12 of the frame, as denoted by arrow 64. This further extension of the jacks 42 is continued until, as shown in FIG. 4, the height HF of the frame's front end from the ground surface and the angle of inclination A between the ground surface G and the frame 10 are great enough to also lift the transport wheels 18 off the ground surface G.

At this point, driven rotation of the drive unit motor is terminated, and the jacks are held at their current state of extension to maintain this angle of inclination. With the frame held steady at this angle, the transport wheels 18 are removed from the frame, as denoted by arrow 66, by unpinning and withdrawing the wheel support shafts from the cross-tube 22 of the frame 10. At this stage, with the front end 12 of the frame 10 notably elevated, the pull tongue 16 is also removed from its detachably pinned connection to the front end 12 of the frame 10, as denoted by arrow 67, if not already having been removed subsequent to its disconnection from the vehicle hitch.

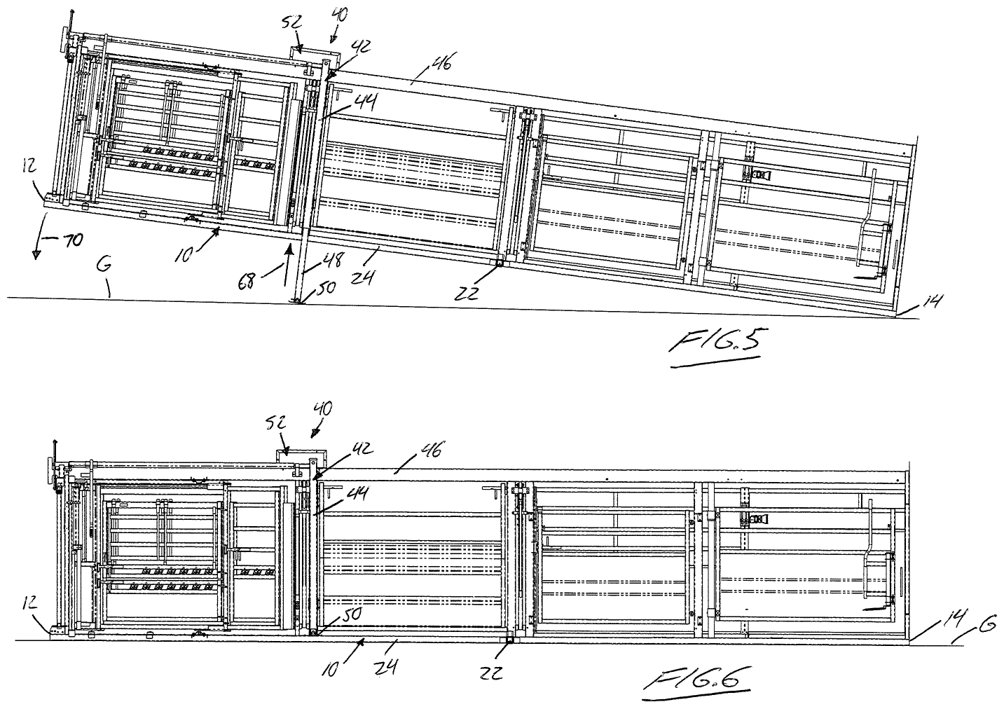

Turning to FIG. 5, with the wheels removed from the frame 10, the jack 42 are collapsed in a controlled manner by the drive unit 52, thus slowly drawing the jack legs 48 upwardly into the jack housings 44, as denoted by arrow 68, in order to slowly lower the front end 12 of the frame 10 back toward the ground surface G, as denoted by arrow 70. This collapse of the jacks 42 and lowering of the front end of the frame is continued until the foot-equipped lower ends of the jack legs 48 are lifted beyond the underside of the frame, thus reducing the inclination angle to zero and laying the frame 10 flat atop the ground surface G, as shown in FIG. 6. In this ground-seated field-use state of the apparatus, livestock at the site can be herded into the force tub, and urged one-by-one into the alleyway using the force tub's movable barrier, in order to receive the livestock one-by-one in the squeeze chute for inspection and/or treatment.

The forgoing procedure for transitioning the apparatus from the wheel-carried transport mode of FIG. 1 to the ground-seated field-use state of FIG. 6 requires only one lifting and lowering operation, performed solely with the front jacks of the apparatus, during which extension of the front jacks enables both disconnection from the tow vehicle and raising of the transport wheels off the ground to enable removal thereof before lowering the frame down to ground level using the same jacks. A singular up-and-down jack cycle is thus all that is required to complete the transition in the front-only jack design of the present invention, where the front jacks are long enough to enable lowering of the rear end of the frame down into contact with the ground and continue lifting the front end relative to the ground-seated rear end until the transport wheels are lifted off the ground. The added mechanical complexities of a movable wheel axis and/or multiple jacking locations is avoided.

Whereas prior art portable corrals employed electric over hydraulic jacks so that a singular motor and pump could be shared by multiple hydraulic jacking mechanisms at different locations along the frame by routing hydraulic lines from the singular pump to those locations, the singular front-only jacking mechanism used in the present invention allows for use of reduced componentry (no pump, reservoir or fluid lines), avoidance of hydraulic leakage risks, and increased energy efficiency by avoiding the need for conversion from electrical to hydraulic power. However, it will be appreciated that the electrically driven jack mechanism of the illustrated embodiment may be substituted by a hydraulic jack mechanism in other embodiments. In yet another embodiment, the front lifting jacks may be manually operated rather than electrically or hydraulically powered.

Also, while the illustrated embodiment is a whose livestock handling equipment includes force tub, alleyway and squeeze chute, the same beneficial front-only lifting configuration may be employed for mobile livestock equipment of other types, such as portable corrals with foldable/unfoldable corral panels pivotally carried atop the frame. In the illustrated embodiment, where the frame defines or carries a floor surface of a pathway through which the livestock travel during use, the apparatus uses a pair of front lifting jacks on opposite outer sides of the frame to provide balanced lifting without obstruction to the livestock travel path through the apparatus. In other embodiments, particularly including those where there's no through-path to obstruct, the quantity and placement of front jacks may vary, and for example may include embodiments with a single-jack lifting mechanism rather than the dual-jack lifting mechanism of the detailed embodiment.

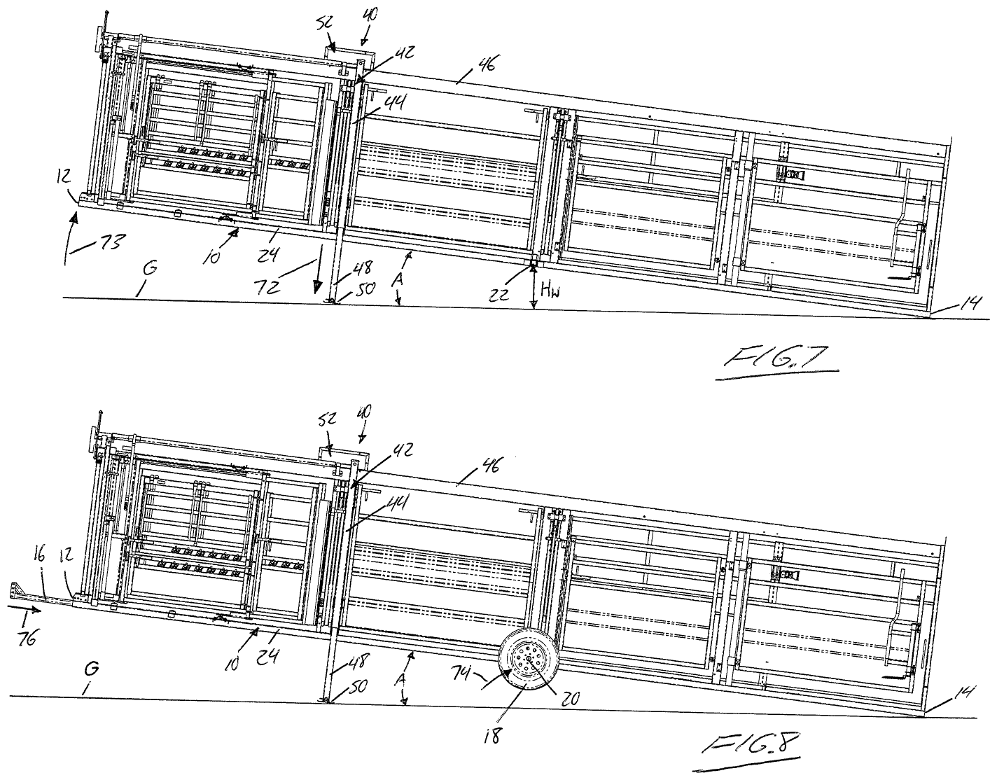

Having addressed transition from the wheeled transport mode to the ground-seated field-use position, similar description is now made of the process of preparing the apparatus for transport by returning the apparatus from the field-use position of FIG. 6 back to the transport position of FIG. 1. Starting with FIG. 7, first the front lift jacks 42 are extended to force the foot-equipped lower ends of the jack legs 48 downwardly against the ground surface, as denoted by arrow 72, in order to once again lift the front end 12 of the frame 10 relative to the ground-seated rear end 14 thereof, as denoted by arrow 73, thus tilting the frame 10 back up into an inclined state. As during the prior front-end lifting performed during the in-field setup of the apparatus to enable removal of the transport wheels, this lifting of the front end 12 of the frame 10 is continued until inclination angle A reaches a value at which the height of the wheel axis Hw from the ground surface G exceeds the measured radius of the transport wheels.

With reference to FIG. 8, this creates enough clearance between the ground surface and the cross-tube 22 of the frame to enable reinstallation of the transport wheels 18, as denoted by arrow 74. The wheel support shafts are inserted into the cross-tube 22 on opposite sides of the frame and are pinned in place. With the frame 10 in this inclined state, the pull tongue 16 is also reinstalled at the front end 12 of the frame 10, as denoted by arrow 76.

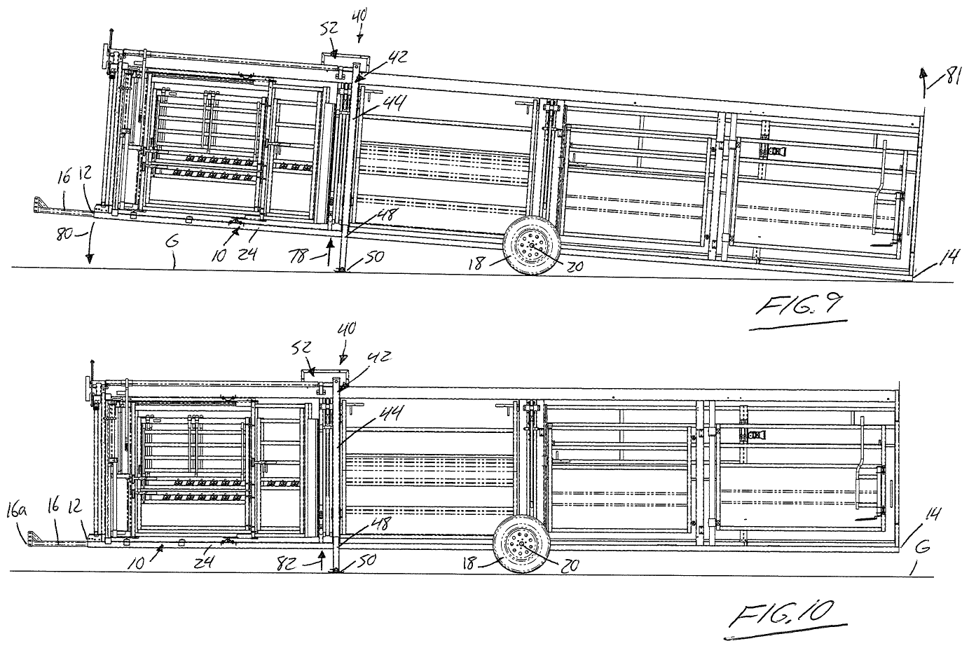

Turning to FIG. 9, the jacks 42 are then collapsed to draw the jack legs 48 upwardly back into the jack housings 44, as denoted by arrow 78, thus lowering the front end 12 of the frame 10 back down toward the ground surface G, as denoted by arrow 80, while simultaneously lifting the rear end 14 of the frame 10, as denoted by arrow 81, thus levelling out the frame into a generally horizontal orientation more parallel to the ground surface. This collapse of the jacks 42 a is continued until the pull tongue 16 is at a suitable elevation to be coupled to the hitch of the tow vehicle. The jacks are held steady at this point to continue cooperating with the wheels 18 to bear the weight of the front section of the apparatus while the leading end 16a of the pull tongue is being coupled to the vehicle hitch.

Turning to FIG. 10, after such coupling of the pull tongue to the vehicle hitch, the jacks are collapsed further, as denoted by arrow 82, thus lifting the feet-equipped lower ends of the jacks legs 48 up off the ground so that the weight of the trailer is now fully borne through a combination of the transports wheels 18 and the pull tongue's connection to the hitch of the tow vehicle. The jacks are collapsed fully to pull the feet 50 of the jack legs 48 up past the underside of the frame 10, thus attaining the wheeled transport state of FIG. 1 where the raised state of the jack legs up off the ground allows towed transport of the hitched apparatus behind the tow vehicle.

From the forgoing, it will be appreciated that like the earlier field setup procedure, the transport preparation procedure involves only a singular up-and-down jacking operation by the front jacks, thus avoiding the need for any rear jacks on the apparatus, while also avoiding the complexities of a movable wheel axis.

Since various modifications can be made in my invention as herein above described, and many apparently widely different embodiments of same made, it is intended that all matter contained in the accompanying specification shall be interpreted as illustrative only and not in a limiting sense.

In the claims:

1. A mobile livestock handling apparatus comprising:
a frame having a front end and opposing rear end spaced apart in a longitudinal direction;
a pull tongue placed, or configured for selective placement, in a position extending longitudinally forward from the front end of the frame for connection to a hitch of a towing vehicle at a leading end of said pull tongue;
transport wheels connected or connectable to the frame at opposing lateral sides thereof at a wheel axis lying transversely of the longitudinal direction at a position situated intermediately of the front and rear ends of the frame in the longitudinal direction; and
a front lifting jack mechanism comprising one or more front lifting jacks that are attached to the frame at a location residing forwardly of the wheel axis, and are extendable down into contact with a ground surface beneath the frame and operable to lift the front end of the frame about the wheel axis and thereby simultaneously lower the rear end of the frame about the wheels axis;
wherein the one or more front lifting jacks are configured to be extendable far enough to lower the rear end of the frame into contact with the ground surface, and subsequently lift the transport wheels off the ground surface.

2. The apparatus of claim 1 wherein the apparatus is free of any rear lifting jacks situated rearwardly of the wheel axis.

3. The apparatus of claim 1 wherein the front lifting jack mechanism resides intermediately of the wheel axis and the front end of the frame in the longitudinal direction.

4. The apparatus of claim 1 wherein a rear section of the apparatus spanning from the wheel axis to the rear end of the frame is lighter than a front section of the apparatus spanning from the wheel axis to the connection end of the pull tongue.

5. The apparatus of claim 1 wherein a center of mass of said apparatus is situated forwardly of the wheel axis.

6. The apparatus of claim 1 wherein said apparatus has a front-heavy weight distribution.

7. The apparatus of claim 1 wherein said front lifting jack mechanism is an only lifting jack mechanism of said apparatus.

8. The apparatus of claim 1 wherein said front lifting jack mechanism is a non-hydraulic lifting jack mechanism.

9. The apparatus of claim 1 wherein said front lifting jack mechanism is an electric lifting jack mechanism.

10. The apparatus of claim 1 wherein said one or more front lifting jacks are spaced from the front end of the frame toward the wheel axis.

11. The apparatus of claim 10 wherein the front lifting jack mechanism comprises a drive motor operable to actuate extension of the one or more front lifting jacks, said drive motor being located closer to said one or more front lifting jacks than to the front end of the frame, in said longitudinal direction.

12. The apparatus of claim 11 comprising a gear train by which the drive motor is operably connected to the one or more front lifting jacks.

13. The apparatus of claim 1 wherein said front lifting jack mechanism comprises a drive motor operable to actuate extension of the one or more front lifting jacks, and a gear train by which the drive motor is operably connected to the one or more front lifting jacks.

14. The apparatus of claim 11 wherein the one or more front lifting jacks comprise two front lifting jacks respectively residing at opposing sides of the frame, said drive motor being carried on the frame between said two front lifting jacks.

15. The apparatus of claim 1 wherein each front lifting jack is extendable and collapsible along a respective actuation axis whose orientation is fixed relative to the frame.

16. The apparatus of claim 1 wherein each front lifting jack comprises a ground foot that is pivotable about a pivot axis that is parallel to the wheel axis and transverse to both the actuation axis of the front lifting jack and the longitudinal direction of the frame.

17. The apparatus of claim 1 comprising a livestock force tub carried on the frame at a location situated more rearwardly than forwardly of the wheel axis.

18. The apparatus of claim 17 comprising a livestock alleyway spanning forwardly from said livestock force tub.

19. The apparatus of claim 1 comprising a livestock squeeze chute carried on the frame at a location situated more forwardly than rearwardly of the wheel axis.

20. The apparatus of claim 18 comprising a livestock squeeze chute at an end of the alleyway situated opposite the livestock force tub.

21. The apparatus of claim 1 wherein the location at which the one or more front lifting jacks are attached to the frame is at a fixed position on said frame.

22. The apparatus of claim 1 wherein the position at which the transport wheels are connected or connectable to the frame is a fixed position thereon.

23. A method of setting up the mobile livestock handling apparatus of claim 1 for field use, said method comprising:
(a) towing said apparatus to an intended setup site using a tow vehicle having a hitch to which the pull tongue of the apparatus is connected;
(b) at said setup site, with the pull tongue of the apparatus still connected to the hitch of the tow vehicle, extending the front lifting jack mechanism down into contact with the ground surface;
(c) with the front lifting jack mechanism extended down into said contact with the ground surface, disconnecting the pull tongue of the apparatus from the hitch of the tow vehicle;
(d) performing further extension of the front lifting jack mechanism to lower the rear end of the frame into contact with said ground surface;
(e) with said rear end of the frame in contact with the ground surface, performing even further extension of the front lifting jack mechanism to increase an inclination angle of the apparatus relative to the ground surface and thereby lift the transport wheels from said ground surface;
(f) with the inclination angle large enough to lift said transport wheels from the ground surface, removing said transport wheels from the frame; and
(g) with the transport wheels removed, collapsing the front lifting jack mechanism to lower the front end of the frame down to the ground surface, thereby laying said frame atop the ground surface.

24. The method of claim 23 comprising, before lowering the front end of the frame into contact with the ground surface in step (g), removing the pull tongue from the frame of the apparatus.

25. A method of preparing the mobile livestock handling apparatus of claim 1 for transport, said method comprising:
(a) with the apparatus initially residing in a ground-seated state with the frame seated on said ground surface and the transport wheels removed, extending the front lifting jack mechanism to lift the front end of the frame to a height at which an inclination angle of said frame relative to the ground surface is great enough that a distance from the wheel axis to the ground surface exceeds a radius of the transport wheels;
(b) with the apparatus at said inclination angle, installing the transport wheels on the frame;
(c) collapsing the front lifting jack to lower the front end of the frame, thereby reducing said inclination angle and lowering said transport wheels into contact with said ground surface;
(d) with the transport wheels in said contact with the ground surface, further collapsing the front lifting jack mechanism to lift the rear end of the frame from the ground surface;
(e) with the pull tongue in an installed position reaching forwardly from the front end of the frame, collapsing the front lifting jack mechanism even further to lower the pull tongue into connectable relation to a hitch of a tow vehicle;
(f) connecting the pull tongue to said hitch; and
(g) with the pull tongue connected to said hitch, further collapsing the front lifting jack to a raised position lifted from the ground surface to enable towing of the apparatus on the transport wheels via the pull tongue and the hitch.

26. The method of claim 25 wherein the pull tongue is not in the installed position in the initial ground-seated state of step (a), and the method comprises installing the pull tongue on the frame prior to step (e) and after initial lifting of the front end of the frame in step (a).

27. (canceled)

28. (canceled)

29. (canceled)

30. (canceled)

31. The apparatus of claim 1 wherein said front lifting jack mechanism is a powered lifting jack mechanism.

32. The apparatus of claim 1 wherein said front lifting mechanism is a motor-powered lifting jack mechanism.
